(19) United States
(12) Patent Application Publication
(10) Pub. No.: US 2026/0067173 A1
(43) Pub. Date: Mar. 5, 2026

(54) AI/ML MODEL MANAGEMENT AND ACTIVATION/DEACTIVATION

(71) Applicant: APPLE INC., Cupertino, CA (US)

(72) Inventors: Peng Cheng, Beijing (CN); Alexander Sirotkin, Hod Hasharon (IL); Yuqin Chen, Beijing (CN); Ping-Heng Kuo, London (GB); Haijing Hu, Los Gatos, CA (US)

(21) Appl. No.: 19/103,601

(22) PCT Filed: Aug. 22, 2022
(86) PCT No.: PCT/CN2022/113894

§ 371 Date: Feb. 13, 2025

(51) Int. Cl. H04L 41/16; H04W 72/231; H04W 72/51; H04W 76/20

(52) U.S. Cl. CPC H04L 41/16; H04W 72/231; H04W 72/51; H04W 76/20

(57) ABSTRACT

Apparatuses, systems, and methods for AI/ML model management and activation/deactivation. A wireless device comprising at least one antenna and a processor is configured to: receive a configuration message from a network device, the configuration message comprising indication information of a list of Artificial Intelligence (AI) models, wherein the configuration message further comprises an activation field indicating a first AI model in the list of AI models to be activated; and activate the first AI model indicated by the activation field.

### TECHNICAL FIELD

This application relates generally to wireless communication systems, including apparatus, systems, and methods for AI/ML model management and activation/deactivation in wireless communication systems.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Artificial intelligence (AI) is the simulation of human intelligence processes by machines, usually computer systems. Machine learning (ML) is a subset of AI that creates algorithms and statistical models to perform a specific task without using explicit instructions, relying instead on patterns and inference. ML algorithms build mathematical models based on sample data, called training data, to make predictions or decisions without being programmed specifically for that task. Learned signal processing algorithms can empower the next generation of wireless systems with significant reductions in power consumption and improvements in density, throughput, and accuracy when compared to the brittle and manually designed systems of today.

### SUMMARY

The present disclosure provides apparatus, systems, and methods for AI/ML model management and activation/deactivation in wireless communication systems.

Embodiments disclosed herein include a wireless device, comprising: at least one antenna; and a processor configured to: receive a configuration message from a network device, the configuration message comprising indication information of a list of Artificial Intelligence (AI) models, wherein the configuration message further comprises an activation field indicating a first AI model in the list of AI models to be activated; and activate the first AI model indicated by the activation field.

Embodiments disclosed herein include a network device, comprising: at least one antenna; and a processor configured to: receive capability information indicating AI capability from a wireless device; and transmit a configuration message to the wireless device, the configuration message comprising indication information of a list of Artificial Intelligence (AI) models, wherein the configuration message further comprises an activation field indicating a first AI model in the list of AI models to be activated.

Embodiments disclosed herein include a method performed by a wireless device, comprising: receiving a configuration message from a network device, the configuration message comprising indication information of a list of Artificial Intelligence (AI) models, wherein the configuration message further comprises an activation field indicating a first AI model in the list of AI models to be activated; and activating the first AI model indicated by the activation field.

Embodiments disclosed herein include a method performed by a network device, comprising: receiving capability information indicating AI capability from a wireless device; and transmitting a configuration message to the wireless device, the configuration message comprising indication information of a list of Artificial Intelligence (AI) models, wherein the configuration message further comprises an activation field indicating a first AI model in the list of AI models to be activated.

Embodiments disclosed herein include a non-transitory computer-readable storage medium, having instructions stored thereon, which, when executed by a processor of a wireless device, cause the processor to: receive a configuration message from a network device, the configuration message comprising indication information of a list of Artificial Intelligence (AI) models, wherein the configuration message further comprises an activation field indicating a first AI model in the list of AI models to be activated; and activate the first AI model indicated by the activation field.

Embodiments disclosed herein include a non-transitory computer-readable storage medium, having instructions stored thereon, which, when executed by a processor of a network device, cause the processor to: receive capability information indicating AI capability from a wireless device; and transmit a configuration message to the wireless device, the configuration message comprising indication information of a list of Artificial Intelligence (AI) models, wherein the configuration message further comprises an activation field indicating a first AI model in the list of AI models to be activated.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example functional framework of AI/ML in wireless communication systems, according to embodiments disclosed herein.

FIG. 4 illustrate an example communication procedure between a UE and a gNB for model configuration and activation, according to embodiments disclosed herein.

FIG. 5 illustrates an example communication procedure between a UE and a gNB for model switch, according to embodiments disclosed herein.

FIG. 6A illustrates an example communication procedure between a UE and a gNB for conditional model deactivation, according to embodiments disclosed herein.

FIG. 6B illustrates another example communication procedure between a UE and a gNB for conditional model deactivation, according to embodiments disclosed herein.

FIG. 7 illustrates an example communication procedure between a UE and a gNB for model management, according to embodiments disclosed herein.

FIG. 8 illustrates an example method performed by a wireless device, according to embodiments disclosed herein.

FIG. 9 illustrates an example method performed by a network device, according to embodiments disclosed herein.

### DETAILED DESCRIPTION

Various embodiments are described with regard to a UE. However, reference to a UE is merely provided for illustrative purposes. The example embodiments may be utilized with any wireless device that may establish a connection to a network and is configured with the hardware, software, and/or firmware to exchange information and data with the network. Therefore, the UE as described herein is used to represent any appropriate wireless device.

Various embodiments are described with regard to a gNB. However, reference to a gNB is merely provided for illustrative purposes. The example embodiments may be utilized with any network device in a network and is configured with the hardware, software, and/or firmware to implement any function of the network. Therefore, the gNB as described herein is used to represent any appropriate network device.

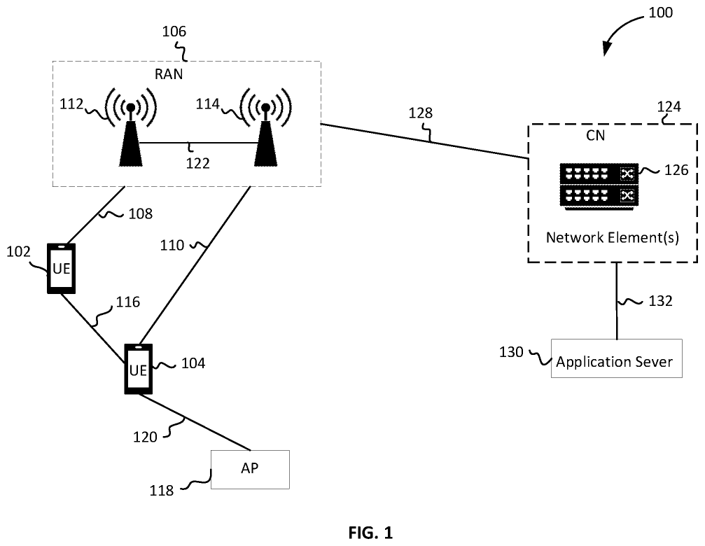

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VOIP sessions, group communication sessions, etc.) for the UE 102 and UE 104 via the CN 124. The application server 130 may communicate with the CN 124 through an IP communications interface 132.

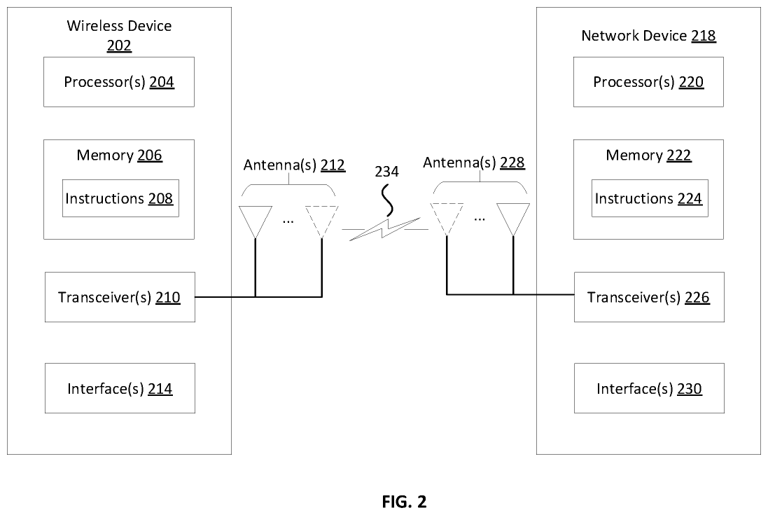

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

AI/ML can be applied to the wireless communication systems. Use cases include Channel State Information (CSI) feedback enhancement (e.g., overhead reduction, improved accuracy, and prediction), Beam Management (BM) (e.g., beam prediction in time, spatial domain for overhead and latency reduction, and beam selection accuracy improvement), and Positioning accuracy enhancements for different scenarios including, e.g., those with heavy NLOS conditions.

Embodiments contemplated herein provides AI/ML model management and activation/deactivation in wireless communication systems.

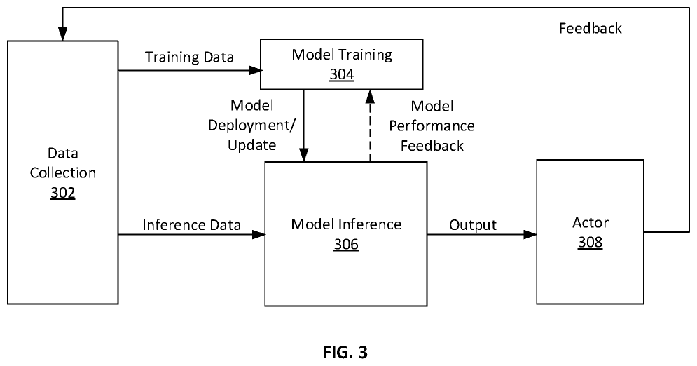

FIG. 3 illustrates an example functional framework of AI/ML in wireless communication systems, according to embodiments disclosed herein.

Data Collection 302 is a function that provides input data to Model training and Model inference functions. AI/ML algorithm specific data preparation (e.g., data pre-processing and cleaning, formatting, and transformation) is not carried out in the Data Collection function. Examples of input data may include measurements from UEs or different network entities, feedback from Actor, output from an AI/ML model. Training Data is data needed as input for the AI/ML Model Training function. Inference Data is data needed as input for the AI/ML Model Inference function.

Model Training 304 is a function that performs the AI/ML model training, validation, and testing which may generate model performance metrics as part of the model testing procedure. The Model Training function is also responsible for data preparation (e.g., data pre-processing and cleaning, formatting, and transformation) based on Training Data delivered by a Data Collection function, if required. Model Deployment/Update is to initially deploy a trained, validated, and tested AI/ML model to the Model Inference function or to deliver an updated model to the Model Inference function.

Model Inference 306 is a function that provides AI/ML model inference output (e.g., predictions or decisions). Model Inference function may provide Model Performance Feedback to Model Training function when applicable. The Model Inference function is also responsible for data preparation (e.g., data pre-processing and cleaning, formatting, and transformation) based on Inference Data delivered by a Data Collection function, if required. Output is the inference output of the AI/ML model produced by a Model Inference function. Details of inference output are use case specific. Model Performance Feedback may be used for monitoring the performance of the AI/ML model, when available.

Actor 308 is a function that receives the output from the Model Inference function and triggers or performs corresponding actions. The Actor may trigger actions directed to other entities or to itself. Feedback is information that may be needed to derive training data, inference data or to monitor the performance of the AI/ML Model and its impact to the network through updating of KPIs and performance counters.

Example communication procedures will be described below to illustrate various aspects of the present disclosure. The example communication procedures are described with regard to AI. However, reference to AI is merely provided for illustrative purposes, and it can be replaced with ML.

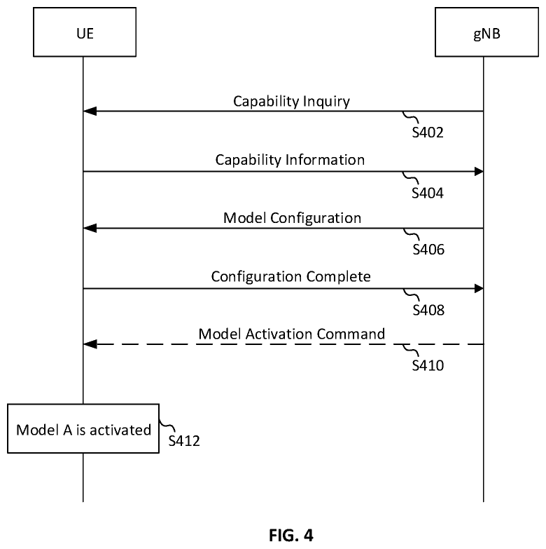

FIG. 4 illustrates an example communication procedure between a UE and a gNB for model configuration and activation, according to embodiments disclosed herein.

Before model configuration, the UE and the gNB may perform UE capability exchange on AI to determine which AI models can be applied to the UE. At step 402, the gNB transmits a capability inquiry to UE when it needs know the UE's capability on AI. At step S404, the UE transmits capability information to the gNB in response to the received capability inquiry. The capability information may indicate the UE's capability on AI. With the capability information, the gNB can determine which AI models can be applied to the UE.

At step S406, the gNB transmits a configuration message to the UE to configure a list of AI models to the UE. The configuration message may include indication information of a list of AI models that can be used by the UE, and may be in form of a Radio Resource Control (RRC) reconfiguration message. The indication information of the list of AI models may comprise a model ID of each AI model in the list of AI models. At step S408, the UE transmits a configuration complete message to the gNB in response to the received configuration message.

At one time instance, only one configured AI model can be activated for the UE. Initial states of the configured AI models may be deactivated. The gNB can notify the UE of an AI model to be activated in various manners.

In some embodiments disclosed herein, the configuration message may comprise an activation field indicating an AI model (e.g., model A) in the list of AI models to be activated. For example, the activation field may include index of the AI model (e.g., model A) to be activated. Therefore, the UE activates the AI model (e.g., model A) directly upon receipt of the configuration message at step S412. If only one AI model is configured in the configuration message, that AI model may be considered to be activated by default.

In some embodiments disclosed herein, the gNB may transmit a model activation command to the UE indicating an AI model (e.g., model A) in the list of AI models to be activated at step S410. Therefore, the UE activates the AI model (e.g., model A) upon receipt of the model activation command at step S412.

The model activation command may be in form of Media Access Control (MAC) Control Element (CE) or a Downlink Control Information (DCI). Mapping of at least a subset of the list of AI models to codepoints of MAC CE/DCI may be comprised in the configuration message. Therefore, the gNB may notify the UE to activate any AI model in the subset via MAC CE/DCI. For an AI model which is not in the subset, the model activation command may be in form of an additional configuration message. The additional configuration message may comprise indication information of the AI model to be activated.

In addition, one or more of the AI models may be configured with a slice scope. For example, the configuration message may comprise applicable slice information indicating applicable slices for the AI models. The AI models will only be applicable for operation/data relating to the indicated applicable slices.

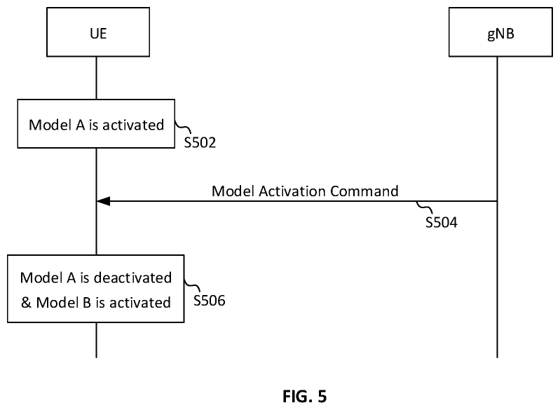

FIG. 5 illustrates an example communication procedure between a UE and a gNB for model switch, according to embodiments disclosed herein. Initially, it is assumed that Model A is activated at the UE at step S502. If it is decided to switch to a new AI model (e.g., Model B) in a list of AI model configured in a configuration message (e.g., in response to performance degradation), the gNB transmits a model activation command indicating the new AI model to the UE at step S504. If the new model has been mapped to codepoints of MAC CE or DCI in a configuration message, the model activation command may be in form of MAC CE/DCI. If the new model has not been mapped to codepoints of MAC CE or DCI in the configuration message, the model activation command may be in form of an additional configuration message. The additional configuration message may comprise indication information of the new AI model to be activated. At step S506, the UE activates the new AI model (e.g., model B) upon receipt of the model activation command.

The AI model activated at the UE may be associated with one or more deactivation conditions configured by the gNB via a configuration message. If one of the deactivation conditions for the AI model is met, the AI model can be deactivated at the UE. Table 1 lists some examples of the deactivation condition.

TABLE 1
Deactivation Condition

UE battery < threshold
Radio quality (RSRP/RSRQ/SINR) < threshold
UE mobility speed > threshold
Indoor->outdoor or outdoor ->indoor
Height > threshold or height < threshold
Out of a geographical location range
Inference accuracy < threshold
Inference integrity < threshold
Inference latency > threshold
Validate duration > threshold

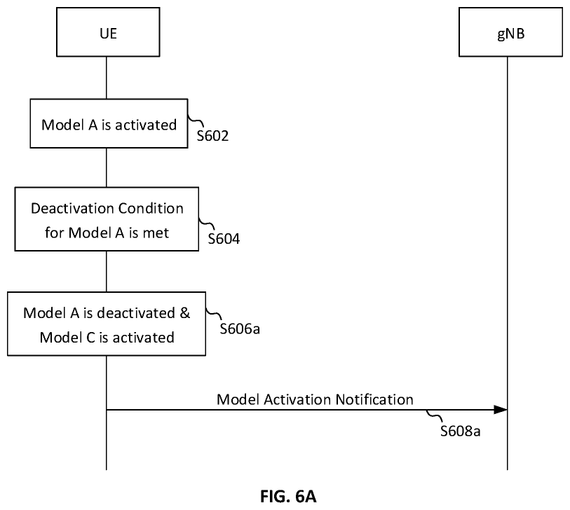

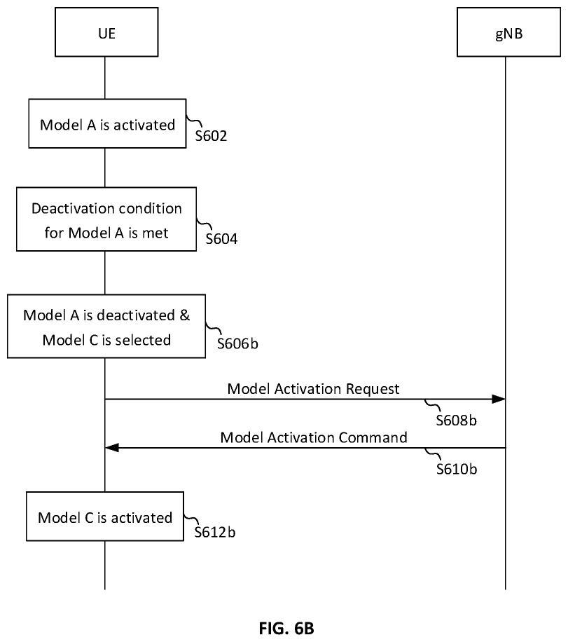

FIG. 6A illustrates an example communication procedure between a UE and a gNB for conditional model deactivation, according to embodiments disclosed herein. Initially, it is assumed that Model A is activated at the UE at step S602. At step S604, the UE determines that a deactivation condition for model A is met. At step S606a, the UE deactivates model A, selects and activates a new AI model (e.g., Model C) in a list of AI models configured by the gNB via a configuration message. When the UE selects a new AI model, it may consider a deactivation condition (if any) associated with the new AI model. The UE may select a new AI model whose deactivation condition is not met, such that the new AI model can match the current communication condition of the UE. At step S608a. The UE transmits a model activation notification to the gNB indicating that the new AI model (e.g., Model C) is activated. The model activation notification may comprise indication information of the new AI model, and may be in form of User Assisted Information (UAI).

FIG. 6B illustrates another example communication procedure between a UE and a gNB for conditional model deactivation, according to embodiments disclosed herein. Initially, it is assumed that Model A is activated at the UE at step S602. At step S604, the UE determines that a deactivation condition for model A is met. At step S606b, the UE deactivates model A and selects another AI model (e.g., Model C). When the UE selects a new AI model, it may consider a deactivation condition (if any) associated with the new AI model. The UE may select a new AI model whose deactivation condition is not met, such that the new AI model can match the current communication condition of the UE.

However, unlike the procedure in FIG. 6A, the UE does not activate the selected AI model immediately. Instead, the UE transmits a model activation request to the gNB requesting switch to the selected AI model at step S608b. The model activation request may comprise indication information of the selected AI model, and may be in form of User Assisted Information (UAI).

At step S610b, the gNB transmits a model activation command indicating a new AI model to the UE. The new AI model may be the AI model selected by the UE, or it may be a different AI model selected by the gNB. If the new AI model has been mapped to codepoints of MAC CE/DCI in a configuration message, the model activation command may be in form of MAC CE/DCI. If the new model has not been mapped to codepoints of MAC CE/DCI in a configuration message, the model activation command may be in form of an additional configuration message. The additional configuration message may comprise indication information of the new AI model to be activated.

At step S612b, the UE activates the new AI model upon receipt of the model activation command. Though it is shown in FIG. 6B that the gNB instructs the UE to switch to the AI model selected by the UE. However, the gNB may instruct the UE to switch to a different AI model selected by the gNB.

If all AI models in the existing list of AI models have been deactivated, the UE may stop use of AI, and may fall back to conventional methods without using AI for certain functionalities (e.g., CSI feedback, Beam Management, Positioning, etc.).

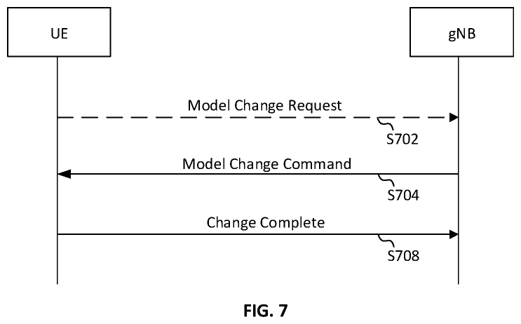

In addition, gNB may perform management for the AI models in the existing list of AI models. FIG. 7 illustrates an example communication procedure between a UE and a gNB for model management, according to embodiments disclosed herein.

The model management may be initiated by either the UE or gNB. In case of initiation by UE, the UE may transmit a model change request to the gNB at step S702. The model change request may comprise a preferred change of an existing list of AI models, and may be in form of User Assisted Information (UAI). In response to the received model change request, the gNB may transmit a model change command to the UE to instruct a change of the existing list of AI models at step S704. The instructed change comprised in the model change command may be different from the requested change comprised in the model change request. That is to say, if the gNB think a different change may be more appropriate, it may comprise the different change in the model change command.

In case of initiation by gNB, the gNB may transmit a model change command to the UE initiatively at step S704. In response to the model change command, the UE transmits a change complete message to gNB at step S708.

The change of the list of AI models may comprise one or more of model addition, model release or model modification. Model addition is to add at least one new AI model into the existing list of AI models. Model release is to release at least one model from the existing list of AI models. Model modification is to modify at least one model in the existing list of AI models (e.g. change of some parameters of some layers of a deep learning model, or removement/addition of some input to a model).

If all AI models have been released from the list, the UE may stop use of AI, and may fall back to conventional methods without using AI for certain functionalities (e.g., CSI feedback, Beam Management, Positioning, etc.). In addition, the UE may transmit User Assisted Information (UAI) comprising its preference for AI to the gNB. The preference may comprise whether the UE prefers to use AI or conventional methods.

Various embodiments are described above with regard to a UE and a gNB. However, as indicated previously, the UE as described herein is used to represent any appropriate wireless device, and the gNB as described herein is used to represent any appropriate network device.

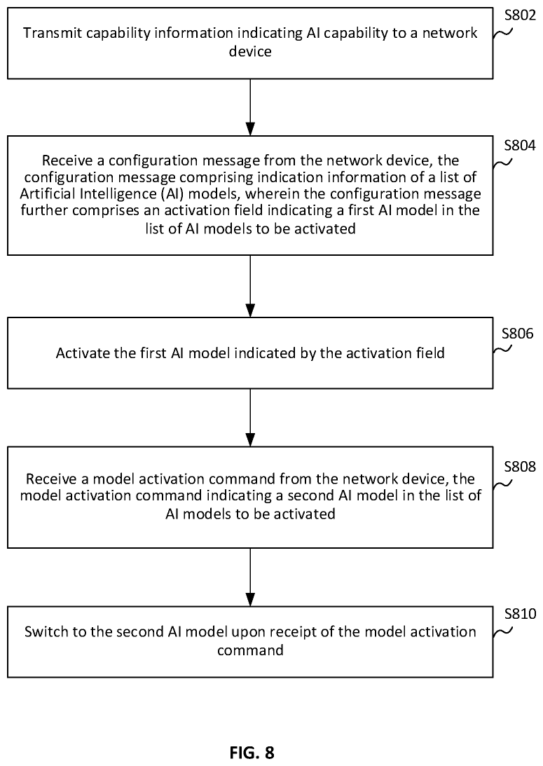

FIG. 8 illustrates an example method performed by a wireless device, according to embodiments disclosed herein. At step S802, the wireless device transmits capability information indicating AI capability to a network device. The capability information may be used by the network device to determine which AI models can be applied to the wireless device. At step S804, the wireless device receives a configuration message from the network device, the configuration message comprising indication information of a list of Artificial Intelligence (AI) models, wherein the configuration message further comprises an activation field indicating a first AI model in the list of AI models to be activated. At step S806, the wireless device activates the first AI model indicated by the activation field. If it is decided to deactivate the first AI model and switch to the second AI model, steps S808 and S810 may be performed. At step S808, the wireless device receives a model activation command from the network device, the model activation command indicating a second AI model in the list of AI models to be activated. At step S810, the wireless device switches to the second AI model upon receipt of the model activation command. That is, the wireless device deactivates the first AI model, and activates the second AI model.

Any of the steps described above with reference to UE can be performed by the wireless device, and are not repeatedly described here for brevity's sake. In addition, not all of the steps shown in FIG. 8 are necessary, and the wireless device may only perform one or more of the steps.

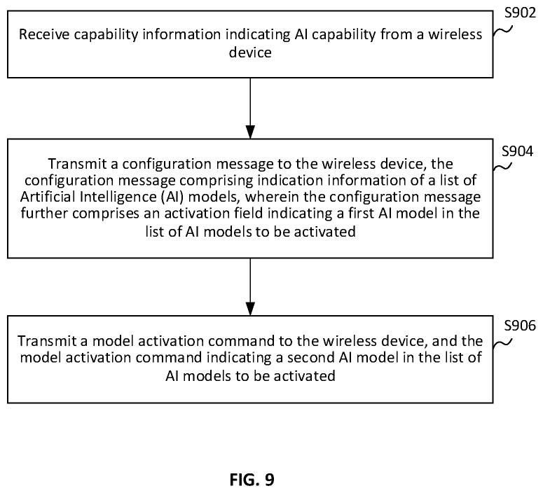

FIG. 9 illustrates an example method performed by a network device, according to embodiments disclosed herein. At step S902, the network device receives capability information indicating AI capability from a wireless device. The capability information may be used by the network device to determine which AI models can be applied to the wireless device. At step S904, the network device transmits a configuration message to the wireless device, the configuration message comprising indication information of a list of Artificial Intelligence (AI) models, wherein the configuration message further comprises an activation field indicating a first AI model in the list of AI models to be activated. If it is decided to deactivate the first AI model and switch to the second AI model, steps S906 may be performed. At step S906, the network device transmits a model activation command to the wireless device, and the model activation command indicating a second AI model in the list of AI models to be activated.

Any of the steps described above with reference to gNB can be performed by the network device, and are not repeatedly described here for brevity's sake. In addition, not all of the steps shown in FIG. 9 are necessary, and the network device may only perform one or more of the steps.

Embodiments contemplated herein include a wireless device, comprising: at least one antenna; and a processor configured to: receive a configuration message from a network device, the configuration message comprising indication information of a list of Artificial Intelligence (AI) models, wherein the configuration message further comprises an activation field indicating a first AI model in the list of AI models to be activated; and activate the first AI model indicated by the activation field.

In some embodiments of the present disclosure, the indication information of the list of AI models comprises model IDs of the list of AI models.

In some embodiments of the present disclosure, the configuration message is an RRC reconfiguration message.

In some embodiments of the present disclosure, the processor is further configured to transmit capability information indicating AI capability to the network device.

In some embodiments of the present disclosure, the processor is further configured to: receive a model activation command from the network device, the model activation command indicating a second AI model in the list of AI models to be activated, and switch to the second AI model upon receipt of the model activation command.

In some embodiments of the present disclosure, the model activation command is a MAC CE or DCI, the configuration message comprising mapping of at least a subset of the list of AI models to codepoints of the MAC CE or the DCI, the subset comprising the second AI model.

In some embodiments of the present disclosure, the model activation command is an additional configuration message, the additional configuration message comprising indication information of the second AI model.

In some embodiments of the present disclosure, the configuration message further comprises a deactivation condition associated with an AI model in the list of AI models.

In some embodiments of the present disclosure, the deactivation condition comprises one or more of: battery of the wireless device being below a threshold; radio quality of the wireless device being below a threshold; mobility speed of the wireless device being above a threshold; movement of the wireless device from indoor to outdoor or from outdoor to indoor; height of the wireless device being above a threshold or below a threshold; the wireless device being out of a geographical location range; inference accuracy of the wireless device being below a threshold; inference integrity of the wireless device being below a threshold; inference latency of the wireless device being above a threshold; or validate duration of the wireless device being above a threshold.

In some embodiments of the present disclosure, the processor is further configured to deactivate a current activated AI model if the deactivation condition associated with the current activated AI model is met.

In some embodiments of the present disclosure, the processor is further configured to: select a third AI model in the list of AI models to be activated; and transmit indication information of the selected third AI model to the network device.

In some embodiments of the present disclosure, the processor is further configured to stop use of AI if all AI models in the list of AI models have been deactivated.

In some embodiments of the present disclosure, the processor is further configured to receive a model change command from the network device, the model change command comprises a change of the list of AI models, and the change of the list of AI models comprises one or more of model addition, model release or model modification.

In some embodiments of the present disclosure, the processor is further configured to transmit a preferred change of the list of AI models to the network device.

In some embodiments of the present disclosure, the processor is further configured to transmit User Assisted Information (UAI) comprising its preference for AI to the network device.

In some embodiments of the present disclosure, the configuration message further comprises applicable slice information associated with an AI model in the list of AI models.

Embodiments contemplated herein include an apparatus comprising means to perform one or more elements of the method comprising: receiving a configuration message from a network device, the configuration message comprising indication information of a list of Artificial Intelligence (AI) models, wherein the configuration message further comprises an activation field indicating a first AI model in the list of AI models to be activated; and activating the first AI model indicated by the activation field. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method comprising: receiving a configuration message from a network device, the configuration message comprising indication information of a list of Artificial Intelligence (AI) models, wherein the configuration message further comprises an activation field indicating a first AI model in the list of AI models to be activated; and activating the first AI model indicated by the activation field. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method comprising: receiving a configuration message from a network device, the configuration message comprising indication information of a list of Artificial Intelligence (AI) models, wherein the configuration message further comprises an activation field indicating a first AI model in the list of AI models to be activated; and activating the first AI model indicated by the activation field. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method comprising: receiving a configuration message from a network device, the configuration message comprising indication information of a list of Artificial Intelligence (AI) models, wherein the configuration message further comprises an activation field indicating a first AI model in the list of AI models to be activated; and activating the first AI model indicated by the activation field. This apparatus may be, for example, an apparatus of a UE (such as a wireless device 202 that is a UE, as described herein).

Embodiments contemplated herein include a signal as described in or related to one or more elements of the method comprising: receiving a configuration message from a network device, the configuration message comprising indication information of a list of Artificial Intelligence (AI) models, wherein the configuration message further comprises an activation field indicating a first AI model in the list of AI models to be activated; and activating the first AI model indicated by the activation field.

Embodiments contemplated herein include a computer program or computer program product comprising instructions, wherein execution of the program by a processor is to cause the processor to carry out one or more elements of the method comprising: receiving a configuration message from a network device, the configuration message comprising indication information of a list of Artificial Intelligence (AI) models, wherein the configuration message further comprises an activation field indicating a first AI model in the list of AI models to be activated; and activating the first AI model indicated by the activation field. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include a network device, comprising: at least one antenna; and a processor configured to: receive capability information indicating AI capability from a wireless device; and transmit a configuration message to the wireless device, the configuration message comprising indication information of a list of Artificial Intelligence (AI) models, wherein the configuration message further comprises an activation field indicating a first AI model in the list of AI models to be activated.

In some embodiments of the present disclosure, the indication information of the list of AI models comprises model IDs of the list of AI models.

In some embodiments of the present disclosure, the configuration message is an RRC reconfiguration message.

In some embodiments of the present disclosure, the processor is further configured to receive capability information indicating AI capability from the wireless device.

In some embodiments of the present disclosure, the processor is further configured to transmit a model activation command to the wireless device, and the model activation command indicating a second AI model in the list of AI models to be activated.

In some embodiments of the present disclosure, the model activation command is a MAC CE or DCI, and the configuration message further comprises mapping of at least a subset of the list of AI models to codepoints of the MAC CE or the DCI, the subset comprising the second AI model, or the model activation command is an additional configuration message, the additional configuration message comprising indication information of the second AI model.

In some embodiments of the present disclosure, the configuration message further comprises a deactivation condition associated with an AI model in the list of AI models.

In some embodiments of the present disclosure, the deactivation condition comprises one or more of: battery of the wireless device being below a threshold; radio quality of the wireless device being below a threshold; mobility speed of the wireless device being above a threshold; movement of the wireless device from indoor to outdoor or from outdoor to indoor; height of the wireless device being above a threshold or below a threshold; the wireless device being out of a geographical location range; inference accuracy of the wireless device being below a threshold; inference integrity of the wireless device being below a threshold; inference latency of the wireless device being above a threshold; or validate duration of the wireless device being above a threshold.

In some embodiments of the present disclosure, the processor is further configured to receive indication information of a selected third AI model from the wireless device.

In some embodiments of the present disclosure, the processor is further configured to transmit a model change command to the wireless device, the model change command comprises a change of the list of AI models, and the change of the list of AI models comprises one or more of model addition, model release or model modification.

In some embodiments of the present disclosure, the processor is further configured to receive User Assisted Information (UAI) comprising preference for AI from the wireless device.

In some embodiments of the present disclosure, the configuration message further comprises applicable slice information associated with an AI model in the list of AI models.

Embodiments contemplated herein include an apparatus comprising means to perform one or more elements of the method comprising: receiving capability information indicating AI capability from a wireless device; and transmitting a configuration message to the wireless device, the configuration message comprising indication information of a list of Artificial Intelligence (AI) models, wherein the configuration message further comprises an activation field indicating a first AI model in the list of AI models to be activated. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method comprising: receiving capability information indicating AI capability from a wireless device; and transmitting a configuration message to the wireless device, the configuration message comprising indication information of a list of Artificial Intelligence (AI) models, wherein the configuration message further comprises an activation field indicating a first AI model in the list of AI models to be activated. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method comprising: receiving capability information indicating AI capability from a wireless device; and transmitting a configuration message to the wireless device, the configuration message comprising indication information of a list of Artificial Intelligence (AI) models, wherein the configuration message further comprises an activation field indicating a first AI model in the list of AI models to be activated. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method comprising: receiving capability information indicating AI capability from a wireless device; and transmitting a configuration message to the wireless device, the configuration message comprising indication information of a list of Artificial Intelligence (AI) models, wherein the configuration message further comprises an activation field indicating a first AI model in the list of AI models to be activated. This apparatus may be, for example, an apparatus of a base station (such as a network device 218 that is a base station, as described herein).

Embodiments contemplated herein include a signal as described in or related to one or more elements of the method comprising: receiving capability information indicating AI capability from a wireless device; and transmitting a configuration message to the wireless device, the configuration message comprising indication information of a list of Artificial Intelligence (AI) models, wherein the configuration message further comprises an activation field indicating a first AI model in the list of AI models to be activated.

Embodiments contemplated herein include a computer program or computer program product comprising instructions, wherein execution of the program by a processing element is to cause the processing element to carry out one or more elements of the method comprising: receiving capability information indicating AI capability from a wireless device; and transmitting a configuration message to the wireless device, the configuration message comprising indication information of a list of Artificial Intelligence (AI) models, wherein the configuration message further comprises an activation field indicating a first AI model in the list of AI models to be activated. The processor may be a processor of a base station (such as a processor(s) 220 of a network device 218 that is a base station, as described herein). These instructions may be, for example, located in the processor and/or on a memory of the base station (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A wireless device, comprising:
at least one antenna; and
a processor configured to:
receive a configuration message from a network device, the configuration message comprising indication information of a list of Artificial Intelligence (AI) models, wherein the configuration message further comprises an activation field indicating a first AI model in the list of AI models to be activated; and
activate the first AI model indicated by the activation field.

2. The wireless device of claim 1, wherein the indication information of the list of AI models comprises model IDs of the list of AI models.

3. The wireless device of claim 1, wherein the configuration message is a Radio Resource Control (RRC) reconfiguration message.

4. The wireless device of claim 1, wherein the processor is further configured to transmit capability information indicating AI capability to the network device.

5. The wireless device of claim 1, wherein the processor is further configured to:
receive a model activation command from the network device, the model activation command indicating a second AI model in the list of AI models to be activated, and
switch to the second AI model upon receipt of the model activation command.

6. The wireless device of claim 5, wherein the model activation command is a Media Access Control (MAC) Control Element (CE) or Downlink Control Information (DCI), the configuration message comprising mapping of at least a subset of the list of AI models to codepoints of the MAC CE or the DCI, the subset comprising the second AI model.

7. The wireless device of claim 5, wherein the model activation command is an additional configuration message, the additional configuration message comprising indication information of the second AI model.

8. The wireless device of claim 1, wherein the configuration message further comprises a deactivation condition associated with an AI model in the list of AI models.

9. The wireless device of claim 8, wherein the deactivation condition comprises one or more of:
battery of the wireless device being below a threshold;
radio quality of the wireless device being below a threshold;
mobility speed of the wireless device being above a threshold;
movement of the wireless device from indoor to outdoor or from outdoor to indoor;
height of the wireless device being above a threshold or below a threshold;
the wireless device being out of a geographical location range;
inference accuracy of the wireless device being below a threshold;
inference integrity of the wireless device being below a threshold;
inference latency of the wireless device being above a threshold; or
validate duration of the wireless device being above a threshold.

10. The wireless device of claim 8, wherein the processor is further configured to deactivate a current activated AI model if the deactivation condition associated with the current activated AI model is met.

11. The wireless device of claim 10, wherein the processor is further configured to:
select a third AI model in the list of AI models to be activated; and
transmit indication information of the selected third AI model to the network device.

12. The wireless device of claim 1, wherein the processor is further configured to stop use of AI if all AI models in the list of AI models have been deactivated.

13. The wireless device of claim 1, wherein the processor is further configured to receive a model change command from the network device, the model change command comprises a change of the list of AI models, and the change of the list of AI models comprises one or more of model addition, model release or model modification.

14. The wireless device of claim 1, wherein the processor is further configured to transmit a preferred change of the list of AI models to the network device.

15. The wireless device of claim 1, wherein the processor is further configured to transmit User Assisted Information (UAI) comprising its preference for AI to the network device.

16. The network device of claim 1, wherein the configuration message further comprises applicable slice information associated with an AI model in the list of AI models.

17. A network device, comprising:
at least one antenna; and
a processor configured to:
receive capability information indicating AI capability from a wireless device; and
transmit a configuration message to the wireless device, the configuration message comprising indication information of a list of Artificial Intelligence (AI) models, wherein the configuration message further comprises an activation field indicating a first AI model in the list of AI models to be activated.

18. The network device of claim 17, wherein the indication information of the list of AI models comprises model IDs of the list of AI models.

19. The network device of claim 17, wherein the configuration message is a Radio Resource Control (RRC) reconfiguration message.

20. The network device of claim 17, wherein the processor is further configured to transmit a model activation command to the wireless device, and the model activation command indicating a second AI model in the list of AI models to be activated.

21-31. (canceled)
